(19) United States
(12) Patent Application Publication
(10) Pub. No.: US 2020/0045631 A1
(43) Pub. Date: Feb. 6, 2020

(54) POWER SAVING PROTOCOL FOR EFFICIENT SLEEP MODE

(71) Applicant: GainSpan Corporation, San Jose, CA (US)

(72) Inventors: Pankaj VYAS, Bangalore (IN); Vishal BATRA, Bangalore (IN)

(73) Assignee: GainSpan Corporation, San Jose, CA (US)

(21) Appl. No.: 16/257,611

(22) Filed: Jan. 25, 2019

(30) Foreign Application Priority Data
Jul. 31, 2018 (IN) 201841028745

(51) Int. Cl. H04W 52/02; H04W 72/12; H04L 5/00; H04W 48/12

(52) U.S. Cl. CPC H04W 52/0216; H04W 52/0229; H04W 48/12; H04L 5/0048; H04W 72/1289

(57) ABSTRACT

A device, system and method are provided for managing network devices in sleep mode or power save mode. Data addressed to devices connected to an access point is temporarily stored. A standard beacon signal and a wake-up beacon signal are transmitted. The standard beacon frame includes information to connect devices to the network and scheduling information identifying broadcast times of the wake-up beacon signals. The scheduling information causes the devices to listen during an identified time for a wake-up beacon signal. The wake-up beacon signal includes traffic indication map information identifying devices that have data addressed thereto, which causes only devices identified to have data addressed thereto to temporarily wake or stay awake from sleep mode or power save mode until the one or more devices retrieve the data addressed thereto.

### CROSS-REFERENCE TO RELATED APPLICATIONS

This application claims priority to Indian patent application 201841028745, filed Jul. 31, 2018 which is incorporated herein by reference in its entirety.

### FIELD OF THE INVENTION

Embodiments of the invention relate to the field of wireless communication and operating network devices in power saving or “sleep modes”. Some embodiments of the invention may be implemented in a medium access control (“MAC”) layer of a wireless local area network (“WLAN”).

### BACKGROUND OF THE INVENTION

In a computing network, an access point (“AP”) or base station is a network hardware device that connects directly to a wireless network, such as, a WLAN. The AP can then provide wireless network connections to stations, such as user equipment (“UE”), which are in its service set (e.g., a group of stations that operate with the same network parameters).

The standard power save mechanism, as defined in the Institute of Electrical and Electronics Engineers (“IEEE”) 802.11 standard, has a station inform an AP when it enters a power savings or sleep mode. When a station is in sleep mode, the AP buffers any data destined for the station, and informs the station of the buffered data by sending a traffic indication map (“TIM”) bit in a beacon signal.

A beacon signal is a network management signal, e.g., utilized in the IEEE 802.11 standard, to enable stations to join and communicate over a WLAN. Beacon signals are typically transmitted periodically, separated by a beacon interval, from APs to stations in the service set in order to announce the presence of a WLAN to initiate connection with the AP, and to synchronize communication among members of the network. Beacon signals typically contain all the information needed to join or communicate over the network. Initially, a station is awake until it receives a first beacon signal, which allows the station to connect to the WLAN. The beacon signal may include one or more time(s), time period(s) or time interval(s) that subsequent beacon signal(s) will be sent. Thereafter, the station can enter power savings or sleep mode, and wake up for those time(s) or time period(s) that the subsequent beacon signal(s) are scheduled to be sent.

When the station periodically wakes up from power save mode, the station checks the TIM field in the beacon signal to determine whether the AP has any buffered frames to transmit to the station. In one example, a TIM is a 64 bit structure used in 802.11 wireless network management beacon signals which include certain bits that indicate the station(s) for which the AP has buffered frames. For example, every station or device associated with the AP may have a unique identification number. e.g., starting from 0. The AP can transmit the TIM via the beacon signal to every associated device, and each associated station or device analyses the TIM to determine if the bit associated with its unique ID is set (i.e., indicating that the AP has buffered data to transmit to that station or device). If a station determines that the bit associated with its unique ID (or a range of IDs for a group of devices to which the station belongs) is set, the station may wake up (or stay awake) from sleep mode for a period that the AP transmits the buffered data; and if not, the station may re-enter sleep mode.

However, beacon signals typically contain a great amount of superfluous information other than the TIM (e.g., network connection information), which is irrelevant to the station that is sleeping (i.e., already connected to the WLAN) in determining whether to wake from or re-enter sleep mode. In order to isolate the TIM, the station must needlessly process this extra irrelevant information, extending the period of time in which the station is awake. This extra processing effort can needlessly drain power from stations receiving the beacon signal when the AP does not have any data buffered for the stations. This is especially problematic for stations that are battery powered and thus have limited energy resources.

Accordingly, there is a need in the art to reduce unnecessary processing by stations in sleep mode to increase power savings.

Further, because beacon signals are meant to reach any network-capable device supporting any transmission rate (even the lowest permitted by the network), beacons are typically transmitted at a relatively slow (e.g., network minimum) transmission rate (e.g., 1 Mbps). Transmitting and receiving beacon signals at this lowest-common transmission rate causes stations in sleep mode to wake up for relatively long periods of time, thereby wasting power, to listen for the TIM in the beacon signal transmitted at such a slow rate.

Accordingly, there is a further need in the art to increase the transmission rate of beacon signals to reduce the duration of time that stations wake up from sleep mode to receive the TIM in the beacon signal.

### SUMMARY OF THE INVENTION

According to some embodiments of the present invention, there is provided device, system, and method, for an access point and method for to manage network devices in sleep mode or power save mode. A memory of the access point may be configured to temporarily store data addressed to one or more devices that are connected to the access point and are in sleep mode or power save mode. A processor of the access point may be configured to broadcast, during a beacon interval, via a transceiver: a standard beacon signal, a wake-up beacon signal, and data from the memory of the access point to device(s) which the data is respectively addressed. The standard beacon signal may include information to connect devices to the network via the access point and scheduling information identifying times during which the transceiver will broadcast one or more wake-up beacon signals during one or more beacon intervals, causing only the devices in sleep mode or power save mode to listen during one or more identified time(s) for a wake-up beacon signal. The scheduling information may cause the one or more devices in sleep mode or power save mode to remain asleep during transmissions of, or ignore, or not download, subsequent standard beacon signals. The wake-up beacon signal may include traffic indication map information identifying one or more of the devices in sleep mode or power save mode that have data addressed thereto stored in the memory, causing only the one or more devices identified to have data addressed thereto to temporarily wake or stay awake from sleep mode or power save mode until the one or more devices retrieve the data addressed thereto.

The wake-up beacon signal may be “slim” or relatively smaller than the “bulky” standard beacon signal. For example, the optional information segment of the frame body of the wake-up beacon may contain only traffic indication map information (or equivalents) and/or may omit the information to connect devices to the network via the access point contained in the standard beacon signal. The wake-up beacon signal may only be received by the one or more devices that are in sleep mode or power save mode during the current beacon interval. In some embodiments of the invention, the wake-up beacon signal may omit information in the standard beacon signal designated as optional by a communication protocol standard. Additionally or alternatively, the wake-up beacon signal may omit information in the standard beacon signal designated as mandatory by a communication protocol standard.

In some embodiments of the invention, the standard beacon signal may only be received by devices that are not in sleep mode or power save mode or that temporarily wake or stay awake from sleep mode or power save mode during the current beacon interval.

In some embodiments of the invention, the processor of the access point may be configured to transmit the standard beacon signals and the wake-up beacon signals at different or alternating times. In some embodiments of the invention, the processor of the access point may be configured to receive supported rates from each of the network devices in sleep mode or power save mode; determine a highest supported data rate common to all of the one or more devices connected to the access point that are in sleep mode or power save mode; and transmit the wake-up beacon signal at the highest common supported data rate. The wake-up beacon signal (transmitted at this highest common supported data rate) will thus generally be transmitted at a faster rate that the standard beacon signal (which is typically transmitted at the lowest network supported data rate).

According to some embodiments of the present invention, there is provided a method, device, and system for a user device, such as a station or UE, operating in sleep mode or power save mode in a network. A processor of the user device may be configured to receive a standard beacon frame to connect to an access point. The standard beacon frame may include scheduling information identifying times during which the transceiver will broadcast one or more wake-up beacon signals during one or more beacon intervals. The processor may be configured to transmit to the connected access point an indication that the device is entering sleep mode or power save mode, and wake up from sleep mode or power save mode during those times identified in the scheduling information to receive from the access point a broadcast of the wake-up beacon signal. The wake-up beacon signal may include traffic indication map information identifying one or more devices in sleep mode or power save mode that have data addressed thereto stored in an access point memory. The processor may be configured to analyze the traffic indication map information to determine if the wake-up beacon signal identifies the device as having data addressed thereto.

The processor may be configured to stay awake until the device retrieves the data if the traffic indication map information identifies the device as having data addressed thereto. The processor may be configured to re-enter sleep mode or power save mode if the traffic indication map information does not identify the device as having data addressed thereto.

### BRIEF DESCRIPTION OF THE DRAWINGS

The foregoing and other objects, features, and advantages of the present invention, as well as the invention itself, is more fully understood from the following description of various embodiments, when read together with the accompanying drawings.

FIG. 1 schematically illustrates an example structure of a standard beacon signal.

FIG. 2 schematically illustrates a system for efficiently operating devices in sleep mode, according to an embodiment of the invention.

FIG. 3 schematically illustrates an example structure of a slim “wake-up” beacon signal, according to an embodiment of the invention.

FIG. 4 is a flowchart of a method for managing network devices in sleep mode or power save mode, according to an embodiment of the invention.

FIG. 5 is a flowchart of a method for managing network devices in sleep mode or power save mode, according to an embodiment of the invention.

FIG. 6 is a flowchart of a method for operating a device in sleep mode or power save mode in a network, according to an embodiment of the invention.

### DETAILED DESCRIPTION OF THE INVENTION

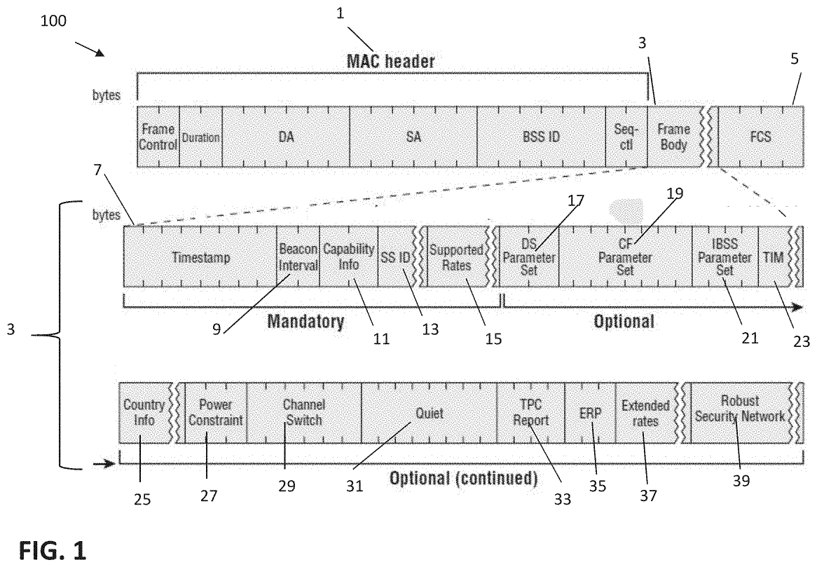

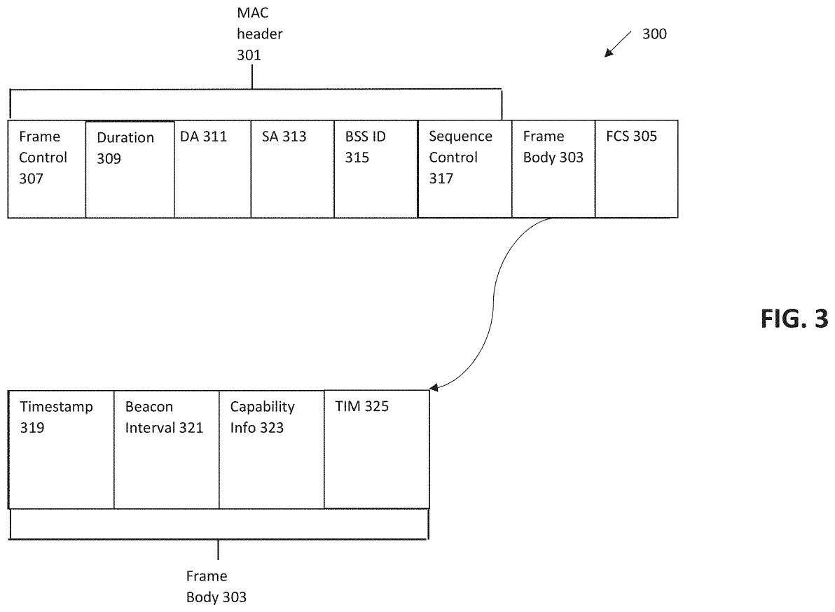

Conventional access points transmit a single standard beacon signal per beacon interval (e.g., the duration of time between two sequential standard beacon signals). According to embodiments of the invention, an access point transmits a pair of beacon signals during a beacon interval including the standard beacon signal as well as a novel “wake-up” beacon” intended to manage devices in sleep mode or power saving mode. The standard beacon signal includes scheduling information identifying times during which the transceiver will broadcast one or more wake-up beacon signals during one or more beacon intervals, causing only the devices in sleep mode or power save mode to listen during an identified time for a wake-up beacon signal. The wake-up beacon may act as a warning or pre-emptive beacon meant only for sleeping devices to inform them if they have data addressed thereto and so should wake-up or stay awake to receive the data addressed thereto in the current beacon interval. The wake-up beacon is typically received only by devices that were in sleep mode during the current beacon interval and that have temporarily awoken to determine if they should stay awake or re-enter sleep mode for the remainder of the current beacon interval or until the next wake-up beacon is scheduled. An example wake-up beacon signal 300 is shown in FIG. 3. This wake-up beacon signal (e.g., in FIG. 3) is significantly smaller and more compact than a standard beacon signal (e.g., as shown in FIG. 1) that contains many fields, such as the information necessary to connect to the WLAN, which are irrelevant to sleeping devices that are already connected to the WLAN.

Unlike the bulky standard beacon signal, the wake-up beacon is relatively slim and may contain only (or substantially only) information relevant to a device's decision of whether or not to wake up from sleep mode (e.g., the TIM or other indicator of buffered data) as its optional information in the frame body. This results in a significant reduction of the size of the beacon signal (e.g., from 200-300 bytes for a typical standard beacon to 42 bytes for a wake-up beacon) and thus, a significant reduction in the wake-up time a device needs to be awake to receive and process the wake-up beacon, as compared to the standard beacon.

Further, the wake-up beacon may be transmitted at a faster rate than the standard beacon. Because the wake-up beacon is intended only for the subset of sleeping devices in a network, the wake-up beacon may be transmitted at a highest supported transmission rate common to the sleeping devices (or all connected devices), which is typically faster than the transmission rate of the standard beacon, which is typically the slowest possible network speed.

The wake-up beacon thereby decreases the beacon signal size and increases the beacon signal transmission rate, resulting in a significant overall reduction in the wake-up time for sleeping devices (e.g., a 300-fold reduction in wake-up time from 2,400 microseconds (μs) for a typical standard beacon to 8 microseconds (μs) for a wake-up beacon).

To further reduce wake-up times for devices in sleep or power save mode, the wake-up beacon may be transmitted less frequently than the standard beacon. For example, the wake-up interval between consecutive wake-up beacons may be larger than the standard beacon interval between standard beacons. For example, a wake-up beacon may be transmitted every two or more standard beacon intervals.

Embodiments of the present invention thus improve the energy efficiency and performance of devices in sleep or power saving modes, by decreasing the wake-up time and amount of information transmitted with the TIM and/or by increasing the speed at which the TIM can be transmitted to UEs.

Reference is made to FIG. 1 which schematically illustrates an example structure of a standard beacon signal 100, modified to support wake-up beacon signaling, according to an embodiment of the invention. The standard beacon signal 100 may include a MAC header 1, a frame body 3, and an error-detecting code referred to as a frame check sequence (“FCS”) 5. The frame body 3 (shown in both collapsed and expanded views) may include mandatory fields and optional fields (various standards may designate different information as mandatory or optional).

Mandatory fields of a typical WLAN beacon signal include, for example, a timestamp 7, a beacon interval 9 scheduling times during which subsequent standard beacons will be transmitted, wake-up beacon scheduling information indicating times during which wake-up beacons will be transmitted (not shown), capability information 11, a service set identifier (“SSID”) 13, and supported transmission rates 15 of the AP. The timestamp 7 may be e.g., an 8-byte value representing the time at the AP (e.g., the number of microseconds the AP has been active). The beacon interval 9 may be e.g., a 2-byte field storing the time interval between beacon transmissions. Capability information 11 may be e.g., a 2-byte field containing a number of subfields that are used to indicate requested or advertised optional capabilities, such as, the capability to support wake-up beacon signaling according to embodiments of the invention. SSID 13 may be e.g., a variable size field including the primary name associated with the WLAN.

Optional fields of a typical WLAN beacon signal include, for example, a direct sequence (“DS”) parameter set 17, a contention free (“CF”) parameter set 19, an independent basic service set (“IBSS”) parameter set 21, traffic indication map (“TIM”) 23 (which may be omitted in the standard beacon 100 if it is transmitted in the wake-up beacon 300 of FIG. 3), country information 25, power constraint information 27, channel switch information 29, quiet time duration 31 during which no UE should transmit, a transmit power control (“TPC”) report 33, extended rate physical (“ERP”) information 35, extended supported rates 37, and robust security network information 39. (Mandatory and optional fields may differ according to various communication protocols.)

In contrast to conventional systems, embodiments of the present invention include an AP sending, and a station or UE receiving, a new “wake-up” beacon, e.g., periodically, after at least one UE is connected to the WLAN (i.e., after the at least one UE has received a standard beacon). Once the UE is connected to the WLAN, the UE already has, and no longer needs to receive, the standard beacon signal containing information for connecting to the WLAN.

The wake-up beacon may include the TIM along with only a subset of the mandatory fields (or a minimal or reduced number of optional fields) of the standard beacon signal. By reducing the amount of information transmitted with the TIM, the TIM can be transmitted by the AP and received by the UEs faster, which reduces the amount of time the UEs must wake up from power saving or sleep mode, which reduces the amount of power consumed by the UEs.

Further, standard beacon signals 100 are typically sent in a WLAN at a relatively slow rate (e.g., 1 Mbps) to allow all types of UEs to be able to receive this information, including older generation devices to allow for backwards compatibility. Standard beacon signals do not adjust this relatively slow rate, even if all the UEs could handle faster rates, or if the beacon data is not intended for UEs which cannot handle faster rates. This needlessly increases the amount of time it takes to transmit the standard beacon signal which increases the amount of time sleeping UEs wake up to receive the standard beacon signals, thereby wasting power, which is especially problematic for battery powered UEs.

The time it takes to receive beacon signals depends on the data rate and size of the beacon signal. For example, a typical standard beacon signal is 300 bytes, and is transmitted at 1 Mbps every 100 ms. Thus, conventional UE's would wake up from a power save mode for 2,400 μs or 2.4 ms for every 100 ms.

In contrast to conventional systems, according to embodiments of the present invention, an AP sends the slim wake-up beacon at the highest commonly supported rate of e.g., all the UEs connected to the AP, the subset of UEs in sleep mode, or the subset of UEs that have buffered information and should wake up from sleep mode. By sending the wake-up beacon at the highest possible supported rate, instead of the standard beacon's lowest possible network rate to support any UE (regardless of whether it is connected to the AP), the wake-up beacon, and thus the TIM transmitted therein, can be transmitted by the AP and received by the UEs faster than by the standard beacon. This reduces the amount of time the UEs are awake (not in power saving mode), which reduces the amount of power consumed by the UEs.

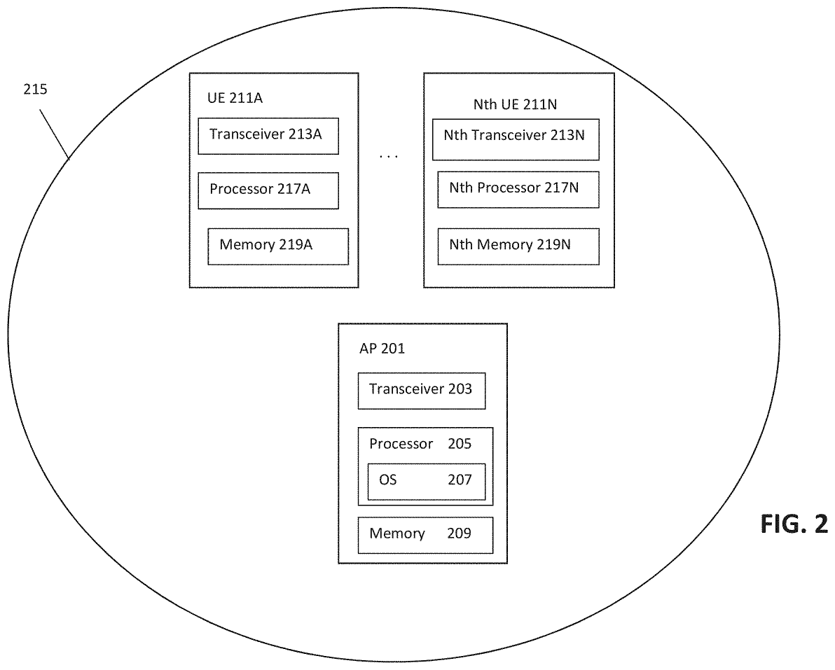

Reference is made to FIG. 2 which schematically illustrates a system for efficiently operating UEs 211A to 211N in sleep mode over a wireless network 215, according to an embodiment of the invention.

The system may include an AP 201 and a plurality of UEs 211A to 211N. UEs 211A to 211N may be (e.g., Wi-Fi) stations, that may connect to the AP 201 over a wireless network 215 (e.g., WLAN). UEs 211A to 211N may include one or more Internet of Things (“IoT”) devices. “smart” devices, personal computers, desktop computers, mobile computers, laptop computers, notebook computers, or any other suitable device such as a cellular telephone, personal digital assistant (PDA), video game console, drone, etc.

The plurality of UEs 211A to 211N may each have a transceiver 213A to 213N, a processor 217A to 217N, and a memory 219A to 219N, respectively. Transceivers 213A and 213N may be configured to transmit or retrieve information to or from the AP 201 over the network 215. The AP 201 may include a transceiver 203 configured to transmit or retrieve information to or from the plurality of UEs 211A to 211N over the network 215. The AP 201 includes one or more processors 205 which can execute software residing in one or more memories 209 to operate an operating system (“OS”) 207. The memory 209 may include, for example, a read only memory (“ROM”), a random access memory (“RAM”), a dynamic RAM (“DRAM”), a flash memory, a volatile memory, a non-volatile memory, a cache memory, a buffer, or other suitable temporary or permanent, long-term or shot-term memory or storage units.

In some embodiments of the invention, the AP 201 is configured to transmit a standard beacon signal (e.g., 100 in FIG. 1), which may include information necessary to connect to the network 215, to at least one UE 211A to 211N. The standard beacon signal (or a separate signal triggered by a sleep mode request) may include scheduling information identifying times during which the transceiver will broadcast one or more wake-up beacon signals during one or more beacon intervals, causing only the devices in sleep mode or power save mode to listen during the identified times for the wake-up beacon signal (e.g., 300 in FIG. 3).

Once the at least one UE 211A to 211N is connected to the network 215 and/or has entered sleep mode, the AP 201 may be configured to transmit the slim wake-up beacon over the network 215. The wake-up beacon may include one or more TIMs to signal to the UEs 211A to 211N whether AP 201 has buffered any data in memory 209 for any of the UEs 211A to 211N. The TIM may cause only the one or more devices identified to have data addressed thereto to temporarily wake or stay awake from sleep mode or power save mode until the one or more devices retrieve the data addressed thereto. The remaining UEs may re-enter sleep or power save mode. The wake-up beacon is typically smaller (e.g., has less bits of information) and is transmitted faster (e.g., at the highest data rate commonly supported by the sleeping UEs) as compared to the standard beacon signal.

In some embodiments of the invention, the AP 201 may be configured to include information, in or with the standard beacon signal or in a separate signal, that advertises or alerts to UEs 211A-211N that AP 201 is configured to or is currently transmitting wake-up beacons (e.g., capability information 11 of FIG. 1). The AP 201 may be configured to include, in or with the standard beacon signal or in a separate signal, the times or time interval that the standard beacon signal will be periodically transmitted (e.g., beacon interval 9 in FIG. 1), and the times or time interval that the wake-up beacon will be periodically transmitted. The AP 201 may be configured to transmit the standard beacon signal and the wake-up beacon signals at the same time or at different times. Once each UE 211A to 211N joins the network 215, the UEs 211A to 211N no longer needs to stay awake during the transmission of subsequent standard beacon signals, but only during the wake-up beacon interval.

Once at least one of the UEs 211A to 211N have connected to the network 215 (e.g., after receiving the first standard beacon signal), and have entered sleep or power save mode, the at least one UEs 211A to 211N may be configured to wake up for the time interval that the wake-up beacon is periodically transmitted. The at least one connected UEs 211A to 211N may be configured to stay asleep during subsequent transmissions of the standard beacon signal, and/or not receive subsequent transmissions of the standard beacon signal.

The UEs 211A to 211N may be configured to wake up (exit power savings mode) for the period of time that transceiver 203 of AP 201 transmits the wake-up beacons in order to determine whether any of UEs 211A to 211N need to retrieve data buffered in memory 209 of AP 201. If the TIM of the wake-up beacon indicates that at least one of the UEs 211A to 211N has data buffered in memory 209, the at least one UEs 211A to 211N may be configured to remain awake and actively transmit a data request signal to the AP 201 to trigger retrieval of the buffered data, or passively wait for the AP 201 to automatically transmit the buffered data. The at least one UEs 211A to 211N are configured to stay awake until the at least one UEs 211A to 211N retrieve the buffered data from memory 209, for the remainder of the beacon interval, or until a timeout period has elapsed. Each of UEs 211A to 211N may be configured to enter power savings mode or go back to sleep after the buffered data has been retrieved, and may be configured to wake-up again when a subsequent wake-up beacon is transmitted.

Receiving a relatively slim wake up beacon to determine whether to stay awake from power save mode, saves a UE a significant amount of power by allowing the UE to remain asleep (not wake up) during the transmission of the relatively larger standard beacons.

In one example, AP 201 may transmit a standard beacon signal (e.g., 100 of FIG. 1) to UEs 211A-211N which includes information about when AP 201 will be transmitting the next one or more slim wake-up beacon(s) (e.g., 300 of FIG. 3) and instructing the UEs 211A-211N to be awake at that time period. Any of UEs 211A-211N may enter sleep mode after receiving the standard beacon signal which informs the UEs 211A-211N to be awake during predefined time periods/intervals. AP 201 may transmit the wake-up beacons to UEs 211A-211N during the predefined time periods/intervals. The UEs 211A-211N may wake from sleep mode during the time periods/intervals that the AP 201 transmits wake-up beacons, and transceivers 213A-213N may receive those wake-up beacons. The wake-up beacons may inform the UEs 211A-211N whether AP 201 has any information buffered in memory 209 to transmit to any of UEs 211A-211N. The wake-up beacons may inform any of UEs 211A-211N, for which AP 201 has buffered information, to stay awake until the UE has retrieved the buffered data. If the AP 201 does not have buffered information for at least one of the UEs 211A-211N, the at least one UE may go back to sleep after transmission of the wake-up beacon,

In some embodiments of the invention, the AP 201 is configured to determine the highest transmission rate supported by all of the connected UEs 211A to 211N, a subset of UEs in sleep mode, or a subset of UEs that have buffered information in memory 209. For example, UEs 211A-211N may be configured to transmit information regarding its supported transmission rates to the AP 201 when UEs 211A-211N connect to AP 201.

In some embodiments of the invention, the transceiver 203 of the AP 201 is configured to transmit the wake-up beacon (e.g., at a rate significantly greater than 1 Mbps, such as 65 Mbps), immediately prior to transmitting the standard beacon signal (e.g., at a rate of 1 Mbps). In some embodiments of the invention, the transceiver 203 of the AP 201 is configured to temporally separate the transmission of the wake-up beacon and the transmission of the standard beacon signal. Transmitting/receiving the wake up beacon at a relatively faster data rate and/or at less frequent intervals than the standard beacons further reduces wake time for devices in sleep or power save modes.

Reference is made to FIG. 3, which schematically illustrates an example signal structure of a slim wake-up beacon signal, according to an embodiment of the invention. Wake-up beacon 300 may include, for example, a MAC header 301, a frame body 303, and a FCS 305. The MAC header 301 may be the same MAC header as used in a standard beacon signal (e.g., MAC header 1 of FIG. 1). The MAC header 301 may include, for example, frame control information 307, a duration or identification information 309, destination address (“DA”) information 311, source address (“SA”) information 313, basic service sets identification (“BSS ID”) information 315, and sequence control information 317.

However, unlike the standard beacon signal 100 of FIG. 1, the frame body 303 of wake-up beacon signal 300 of FIG. 3 may include less information (e.g., less bytes) than the standard beacon signal 100 of FIG. 1. For example, the frame body 303 of the wake-up beacon signal 300, may not include any or all the information used to connect a UE (e.g., one of UE 211A-211N of FIG. 2) to a network (e.g., 215 of FIG. 2). For example, the frame body 303 of wake-up beacon signal 300 may omit any combination of one or more of: the SSID 13, supported transmission rates 15. DS parameter set 17, CF parameter set 19. IBSS parameter set 21, country information 25, power constraint information 27, channel switch information 29, quit time information 31. TPC report 33. ERP information 35, extended supported rates 37, and robust security network information 39 of the standard beacon signal 100 of FIG. 1 (or equivalents in other standards). In some embodiments of the invention, the wake-up beacon signal 300 may omit any of the optional information of the frame body 3 of the standard beacon signal 100 except the TIM 325 (e.g., DS parameter set 17, CF Parameter Set 19, IBSS Parameter Set 21, country information 25, power constraint information 27, channel switch information 29, power constraint information 27, channel switch information 29, quit time information 31, TPC report 33, ERP information 35, extended supported rates 37, and robust security network information 39) (or equivalents in other standards).

In some embodiments of the invention, the wake-up beacon signal 300 only includes mandatory information of the frame body 3 of the standard beacon signal 100 (e.g., timestamp information 319, beacon interval information 321, capability information 323) and wake-up information such as a TIM 325 (or equivalents in other standards). In some embodiments of the invention, the UE can utilize timestamp information 319 and/or beacon interval information 321 to decide when to wake-up next.

In some embodiments of the invention, the wake-up beacon signal 300 omits all the mandatory information of the frame body 3 of the standard beacon signal 100. For example, the wake-up beacon signal 300 may not include the SSID 13 of the standard beacon signal 100 (or equivalents). In embodiments of the invention that include BSS ID information 315, which identifies the AP, the SSID 13 may be omitted in the wake-up beacon signal 300.

In one example, the timestamp information 321 may be an 8-byte value representing a time recorded by an AP (e.g., AP 201 of FIG. 2), such as when the AP transmitted the wake-up beacon signal 300. Beacon interval 321 may be a 2-byte field storing the time interval between wake-up beacon transmissions. Capability information 11 may be a 2-byte field containing a number of subfields that are used to indicate requested or advertised optional capabilities. TIM 325 may include information indicating to any sleeping listening UEs (e.g., UEs 211A to 211N of FIG. 2) if the connected AP has any buffered frames to transmit to any of said UEs.

By reducing the amount of information superfluous to a sleeping device that is transmitted with the TIM 325 in wake-up beacon 300 of FIG. 3, embodiments of the present invention significantly reduce the size of the wake-up beacon 300 compared to a standard beacon signal 100 of FIG. 1. This also reduces the amount of time the UEs remain awake to receive the wake-up beacon 300, which reduces the amount of energy consumed by the UEs.

In one example, a standard beacon signal is approximately 300 bytes or more, whereas, a wake-up beacon signal according to embodiments of the invention may be approximately 65 bytes or less. If all the connected UEs 211A to 211N support rates defined in the IEEE 802.11n standard, of up to 65 Mbps, the AP 201 can be configured to transmit the 65-byte wake-up beacon at that highest common rate of 65 Mbps, which would take approximately 8 μs. In contrast, conventional systems and methods transmit the typical 300-byte beacon signal at 1 Mbps which takes 2.400 μs. Thus, embodiments of the present invention transmit the TIM 325 in the slim wake-up beacon signal approximately 300 times faster than in the bulky standard beacon signal. This means that UEs in sleep mode are woken for a 300th of the duration of the time to receive the slim wake-up beacon signal as compared to the bulky standard beacon signal. Further reductions in wake time may be achieved by transmitting wake-up beacon signals less frequently than standard beacon signals.

In some embodiments, multiple wake-up beacons, each being transmitted at a different data rate, may be transmitted during a single beacon interval. Each different wake-up beacon may be scheduled to be received by UEs that support that rate. Thus, wake-up beacons may be received at the fastest supported rate of each of the UEs, further reducing wake-up times and power loss.

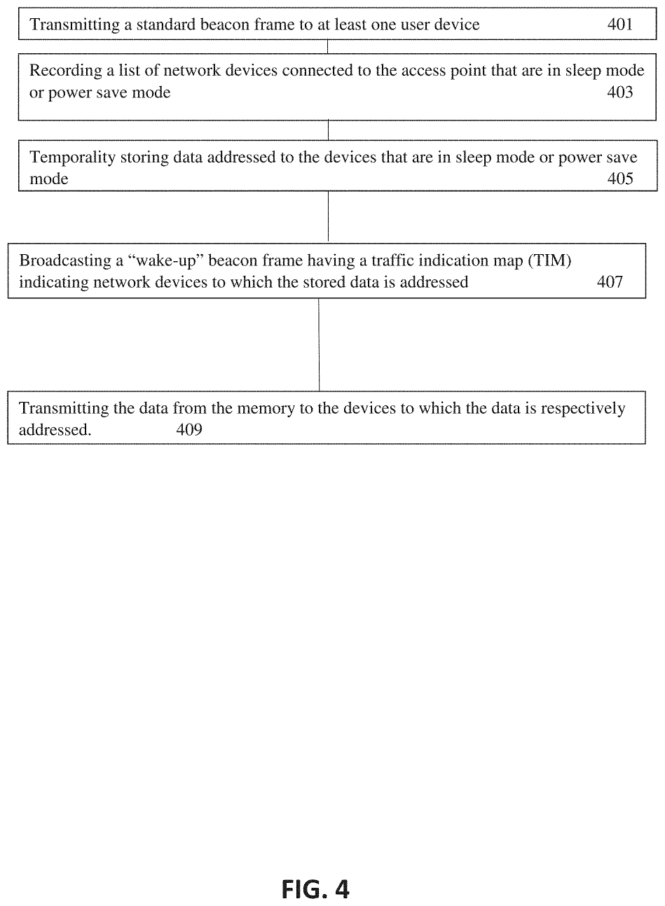

Reference is made to FIG. 4 which is a flowchart of a method for managing network devices in sleep mode or power save mode, according to an embodiment of the invention. The operations of FIG. 4 may be executed by an access point (e.g., AP 201 in FIG. 2) or another device connected to a network (e.g., 215 in FIG. 2).

In operation 401, a processor (e.g., 205 in FIG. 2) of the access point may transmit a standard beacon signal (e.g., 100 in FIG. 1), which may include information necessary for a device (e.g., UE 211A-N in FIG. 2) to connect to the network. The access point may be configured to include information, in or with the standard beacon signal (e.g., capability information 11 of FIG. 1) or in a separate signal, that advertises or alerts to network devices that the access point is configured to transmit wake-up beacons (e.g., 300 in FIG. 3), that the access point is periodically transmitting wake-up beacons, and/or the time periods in which access point transmits the wake-up beacons. For example, the standard beacon signal may also include scheduling information identifying times during which the transceiver will broadcast one or more wake-up beacon signals during one or more beacon intervals, causing only the devices in sleep mode or power save mode to wake up and listen during those identified times to receive the wake-up beacon signals.

In operation 403, the access point may record a list of devices (e.g., one or more of UE 211A-N of FIG. 2) connected to the access point that are in sleep mode or power save mode.

In operation 405, a memory (e.g., 209 of FIG. 2) may temporarily store, cache or buffer data addressed to the devices that are in sleep mode or power save mode until the devices are awake and receive the data.

In operation 407, the access point may broadcast, via a transceiver (e.g., 203 of FIG. 2) over a network (e.g., 215 of FIG. 2), the wake-up beacon signal, which is significantly smaller than the standard beacon signal. The wake-up beacon signal may include traffic indication map information identifying one or more of the devices in sleep mode or power save mode that have data addressed thereto stored in the memory. Wake-up beacon signals may be transmitted at different/non-overlapping or the same/overlapping time(s) or time interval(s) as the standard beacon signals. The traffic map information may cause only the one or more devices identified to have data addressed thereto to temporarily wake or stay awake from sleep mode or power save mode until the one or more devices retrieve the data addressed thereto.

In some embodiments of the invention, the wake-up beacon signal includes the traffic indication map information (e.g., as the only optional data in the frame body) and omits other information designated as optional by a communication protocol standard in the standard beacon signal. For example, the wake-up beacon signal may not include all or any of the information used for new devices to connect to the network.

In some embodiments of the invention, the wake-up beacon signal also omits information designated as mandatory by a communication protocol standard in the standard beacon signal. For example, SSID information, which identifies the AP, is designated as mandatory in standard beacon signals; however, standard beacon signals also include BSS ID information, which also identifies the AP. Because, in some embodiments of the invention, the wake-up beacon may include BSS ID information, the SSID 13 may be omitted in the wake-up beacon signal 300.

In operation 409, the access point may transmit the data from the memory to the devices to which the data is respectively addressed.

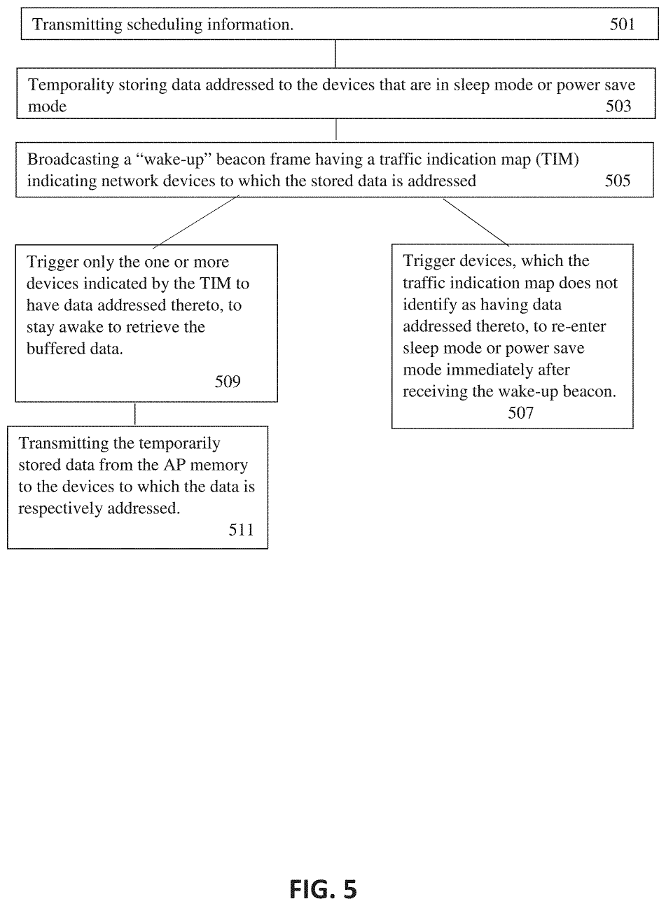

Reference is made to FIG. 5 which is a flowchart of a method for managing network devices in sleep mode or power save mode, according to an embodiment of the invention. The operations of FIG. 5 may be executed by an access point (e.g., AP 201 in FIG. 2) or another device connected to a network (e.g., 215 in FIG. 2).

In operation 501, a processor (e.g., 205 in FIG. 2) of the access point may transmit scheduling information (e.g., in a standard beacon or other signal) identifying times during which the transceiver will broadcast one or more wake-up beacon signals during one or more beacon intervals, causing only the devices in sleep mode or power save mode to wake up and listen during an identified time for a wake-up beacon signal.

In operation 503, a memory (e.g., 209 of FIG. 2) may temporarily store data addressed to the devices that are in sleep mode or power save mode until the devices are awake and receive the data.

In operation 505, the processor may broadcast a “wake-up” beacon frame having a traffic indication map (TIM) indicating devices to which the stored data is addressed.

In operation 507, when the access point transmits a wake-up beacon with traffic indication map information that does not identify a device as having data addressed thereto, the wake-up beacon may trigger the device to re-enter sleep mode or power save mode after the one or more devices receive the wake-up beacon. In some embodiments of the invention, the access point may transmit an explicit instruction, to the one or more devices which have data addressed thereto, to stay awake until the one or more devices retrieve the data from the access point. In other embodiments of the invention, wake-up beacon or TIM information itself serves as an implicitly instruction from the AP to the one or more devices which do not have data addressed thereto to re-enter sleep mode or power save mode after the one or more devices receive the wake-up beacon.

In operation 509, when the access point transmits a wake-up beacon with traffic indication map information that does identify one or more devices as having data addressed thereto, the wake-up beacon may trigger only those one or more devices to stay awake until the one or more devices retrieve the data from the access point. In some embodiments of the invention, the access point may transmit an explicit instruction, to the one or more devices identified which have data addressed thereto, to stay awake until the one or more devices retrieve the data from the access point. In other embodiments of the invention, wake-up beacon or TIM information itself serves as an implicit instruction from the AP to the one or more devices which have data addressed thereto to stay awake until the one or more devices retrieve the data from the access point.

Once the one or more devices, identified to have data addressed, receive the wake-up beacon, the one or more devices may transmit a data request frame to the access point to trigger the AP to retrieve the temporarily stored data, or may passively wait for the access point to automatically transmit the temporarily stored data.

In operation 511, the processor may transmit the temporarily stored data from the memory to the devices to which the data is respectively addressed. The memory may delete the data. e.g., after it is successfully transmitted and received by the addressed device, or after being overwritten by more recent data (e.g., in the current or subsequent beacon period). In one example, every data frame transmitted by the access point to the any connected device is acknowledged in the MAC layer of the WLAN.

In some embodiments of the invention, the access point may receive supported transmission rates from each of the network devices in sleep mode or power save mode. A processor (e.g., 205 of FIG. 2) of the AP may determine a highest supported transmission rate common to all of the network devices connected to the access point that are in in sleep mode or power save mode. The access point may transmit, via the transceiver, the wake-up beacon signal to the stations at the highest commonly supported transmission rate. In some embodiments, different wake-up signals may be transmitted at different rates so that each device may receive the wake-up signal at its highest (or above threshold) supported rate to minimize the wake-up interval and power usage.

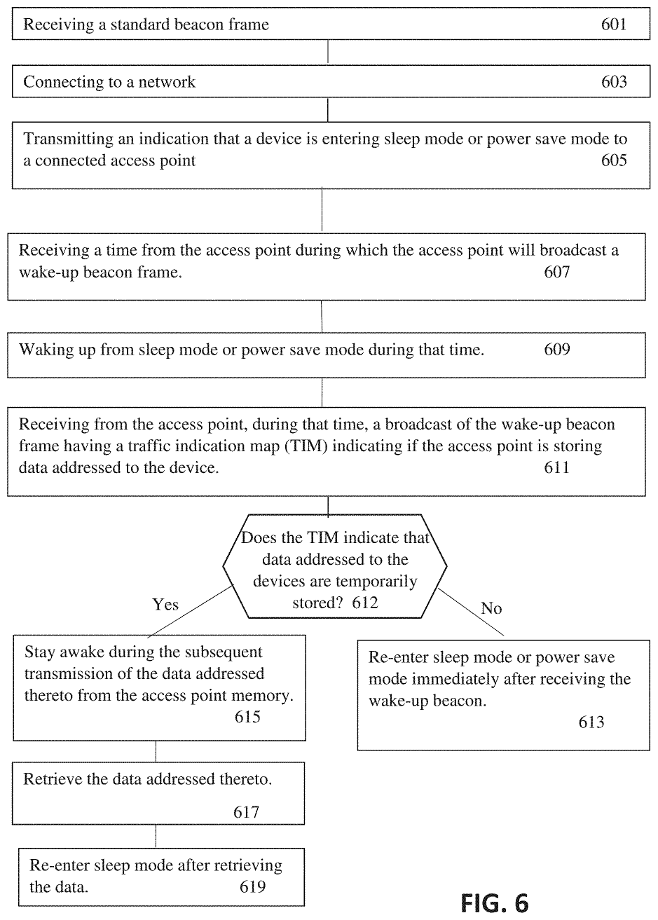

Reference is made to FIG. 6 which is a flowchart of a method for operating a device in sleep mode or power save mode in a network, according to an embodiment of the invention. The operations of FIG. 6 may be executed by one or more stations or UEs (e.g., UE 211A-211N of FIG. 2) or another device connected to a network (e.g., 215 of FIG. 2).

In operation 601, a device (e.g., UE 211A-N of FIG. 2) may receive a standard beacon signal (e.g., 100 in FIG. 1) from an access point (e.g., AP 201 of FIG. 2), which may include network information necessary for the device to connect to the network via the AP, such as SSID 13, supported rates 15, country information 25.

In operation 603, the device may connect to the network using the network information (e.g., 215 in FIG. 2).

In operation 605, the device may transmit, via its transceiver (e.g., transceivers 213A-N of FIG. 2) an indication that the device is entering sleep mode or power save mode, to the connected access point (e.g., AP 201 of FIG. 2).

In operation 607, the device may receive scheduling information from the access point, via a standard beacon or other signal, indicating a time during which the access point will broadcast a wake-up beacon signal.

In operation 609, the processor (e.g., processor 217A-N of FIG. 2) of the device may exit sleep or power save mode and temporarily wake up the device during that wake-up time.

In operation 611, the processor may receive from the access point a broadcast of the wake-up beacon signal during that time. The wake-up beacon signal may include traffic indication map information identifying one or more devices in sleep mode or power save mode that have data addressed thereto temporarily stored in an access point memory (e.g., 209 of FIG. 2). The wake-up beacon signal may be significantly smaller than the standard beacon signal. The wake-up beacon signal may omit all or some of the network information for connecting devices to the network. The wake-up beacon signal may omit information designated as optional by a communication protocol standard for the standard beacon signal. The wake-up beacon signal may omit information designated as mandatory by a communication protocol standard for the standard beacon signal. For example, SSID information, which identifies the AP, is designated as mandatory in standard beacon signals; however, standard beacon signals also include BSS ID information, which also identifies the AP. Because, in some embodiments of the invention, the wake-up beacon may include BSS ID information, the SSID 13 may be omitted in the wake-up beacon signal 300.

In operation 612, the processor may determine if the traffic indication map information in the wake-up beacon signal identifies itself as a device that has data addressed thereto temporarily stored in the access point memory.

In operation 613, if the wake-up beacon signal does not identify the device as having data addressed thereto, the processor may be configured to re-enter sleep mode or power save mode, either immediately after receiving the wake-up beacon, during a subsequent transmission of standard beacon signals, and/or during the following beacon interval. The device to which data is not addressed is thus only awake for the duration of the transmission of the wake-up beacon signal per beacon period, which is relatively shorter (and faster) than the transmission of the corresponding standard beacon signal. The device thus operates in sleep or power save mode for a longer (remains awake for a shorter) amount of time than conventional devices, thereby saving power.

In operation 615, if the wake-up beacon signal does identifies the device as having data addressed thereto, the processor may be configured to stay awake until the device retrieves the data addressed thereto, until the end of the beacon interval, or until a timeout period elapses.

In operation 617, the device may transmit a data request signal to trigger the access point to retrieve and send the data addressed thereto from the access point memory. e.g., according to that network connection information, such as beacon interval information. Alternatively, the device may passively wait for the transmission.

In operation 619, the device may re-enter sleep mode or power saving mode after retrieving the data from the access point. The device may stay asleep until a subsequent transmission of a wake-up beacon is scheduled.

In some embodiments of the invention, the transceiver may be configured to transmit using transmission rates, which are supported by the device, to the access point. The transceiver may receive the wake-up beacon signal at a highest supported transmission rate common to the device and all other network devices connected to the access point that are in sleep mode or power save mode.

While the foregoing is described in reference to “sleep mode,” this invention applies to any power saving mode(s) including but not limited to sleep mode, hibernation mode, hybrid sleep mode, low power mode, stand-by mode, or any other reduced energy modes.

While the foregoing is described in reference to WLANs, this invention applies to any wireless network.

While the foregoing describes a traffic indication map (TIM) field, any other field or information may be used that indicates devices to which stored data is addressed.

In the foregoing description, various aspects of the present invention are described. For purposes of explanation, specific configurations and details are set forth in order to provide a thorough understanding of the present invention. However, it will be apparent to one of ordinary skill in the art that embodiments of the present invention may be practiced without the specific details presented herein. Furthermore, well known features may be omitted or simplified in order not to obscure the present invention.

Although embodiments of the invention are not limited in this regard, discussions utilizing terms such as, for example, “processing.” “computing.” “calculating,” “determining,” “establishing”, “analyzing”. “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

1. An access point for managing network devices in sleep mode or power save mode comprising:
a memory configured to temporarily store data addressed to one or more devices connected to the access point that are in sleep mode or power save mode; and
a processor configured to broadcast during a beacon interval, via a transceiver:
a standard beacon signal comprising information to connect devices to the network via the access point and scheduling information identifying times during which the transceiver will broadcast one or more wake-up beacon signals during one or more beacon intervals, causing only the devices in sleep mode or power save mode to listen during an identified time for a wake-up beacon signal,
a wake-up beacon signal comprising traffic indication map information identifying one or more of the devices in sleep mode or power save mode that have data addressed thereto stored in the memory, causing only the one or more devices identified to have data addressed thereto to temporarily wake or stay awake from sleep mode or power save mode until the one or more devices retrieve the data addressed thereto, and
the data from the memory to the devices to which the data is respectively addressed.

2. The access point of claim 1, wherein the wake-up beacon signal is relatively smaller than the standard beacon signal, wherein the optional information segment of the frame body of the wake-up beacon contains only traffic indication map information and omits the information to connect devices to the network via the access point contained in the standard beacon signal.

3. The access point of claim 1, wherein the wake-up beacon signal is only received by the one or more devices that are in sleep mode or power save mode during the current beacon interval.

4. The access point of claim 1, wherein the standard beacon signal is only received by devices that are not in sleep mode or power save mode or that temporarily wake or stay awake from sleep mode or power save mode during the current beacon interval.

5. The access point of claim 1, wherein the access point transmits the standard beacon signals and the wake-up beacon signals at different times within the current beacon interval.

6. The access point of claim 1, wherein the scheduling information causes the one or more devices in sleep mode or power save mode to:
remain asleep during transmissions of subsequent standard beacon signals, or
not download subsequent standard beacon signals.

7. The access point of claim 1, wherein the processor is configured to:
receive supported rates from each of the network devices in sleep mode or power save mode;
determine a highest supported data rate common to all of the one or more devices connected to the access point that are in sleep mode or power save mode; and
transmit the wake-up beacon signal at the highest common supported data rate.

8. The access point of claim 7, wherein the processor is configured to broadcast the wake-up beacon signals at a higher data rate than the standard beacon signals.

9. The access point of claim 7, wherein the processor is configured to broadcast multiple wake-up beacons, each at a different data rate, during a single beacon interval, and each different wake-up beacon is scheduled to be received by the one or more devices that support that data rate.

9. The access point of claim 1, wherein the processor is configured to broadcast the wake-up beacon signals less frequently than the beacon interval.

10. The access point of claim 1, wherein the wake-up beacon signal omits information in the standard beacon signal designated as optional and/or mandatory by a communication protocol standard.

11. A device for operating in sleep mode or power save mode in a network, comprising:
a processor configured to:
receive a standard beacon frame to connect to an access point, wherein the standard beacon frame includes scheduling information identifying times during which the transceiver will broadcast one or more wake-up beacon signals during one or more beacon intervals, causing only the devices in sleep mode or power save mode to listen during an identified time for a wake-up beacon signal,
transmit to the connected access point an indication that the device is entering sleep mode or power save mode,
wake up from sleep mode or power save mode during the times identified in the scheduling information to receive from the access point a broadcast of the wake-up beacon signal, wherein the wake-up beacon signal comprises traffic indication map information identifying one or more devices in sleep mode or power save mode that have data addressed thereto stored in an access point memory;
analyze the traffic indication map information to determine if the wake-up beacon signal identifies the device as having data addressed thereto; and
if the traffic indication map information identifies the device as having data addressed thereto, staying awake until the device retrieves the data, or
if the traffic indication map information does not identify the device as having data addressed thereto, re-entering sleep mode or power save mode.

12. The device of claim 11, wherein the wake-up beacon signal is relatively smaller than the standard beacon signal, wherein the optional information segment of the frame body of the wake-up beacon contains only traffic indication map information and omits the information to connect devices to the network via the access point contained in the standard beacon signal.

13. The device of claim 11, wherein the processor is configured to:
transmit rates supported by the device to the access point; and
receive the wake-up beacon signal at a highest supported data rate common to the device and all other one or more devices connected to the access point that are in sleep mode or power save mode.

14. The device of claim 11, wherein the processor is configured to receive the wake-up beacon signals at a higher data rate than the standard beacon signals.

15. The device of claim 11, wherein the processor is configured to receive the wake-up beacon signals less frequently than the beacon interval.

16. A method for an access point to manage network devices in sleep mode or power save mode, the method comprising:
temporarily storing, in the memory of an access point, data addressed to one or more devices connected to the access point that are in sleep mode or power save mode;
broadcasting, via a transceiver of the access point:
a standard beacon signal comprising:
information to connect the one or more devices to the network via the access point; and
scheduling information identifying times during which the transceiver will broadcast one or more wake-up beacon signals during one or more beacon intervals, causing only the devices in sleep mode or power save mode to listen during an identified time for a wake-up beacon signal,
a wake-up beacon signal comprising traffic indication map information identifying one or more of the devices in sleep mode or power save mode that have data addressed thereto stored in the memory, causing only the one or more devices identified to have data addressed thereto to temporarily wake or stay awake from sleep mode or power save mode until the one or more devices retrieve the data addressed thereto, and
the data from the memory to the devices to which the data is respectively addressed.

17. The method of claim 16, wherein the wake-up beacon signal is relatively smaller than the standard beacon signal, wherein the optional information segment of the frame body of the wake-up beacon contains only traffic indication map information and omits the information to connect devices to the network via the access point contained in the standard beacon signal.

18. The method of claim 16, wherein the wake-up beacon signal is only received by the one or more devices in sleep mode or power save mode during the current beacon interval.

19. The method of claim 16, wherein the standard beacon signal is only received by devices that are not in sleep mode or power save mode or that temporarily wake or stay awake from sleep mode or power save mode during the current beacon interval.

20. The method of claim 16, wherein the access point transmits the subsequent standard beacon signals and the wake-up beacon signals at different times within the current beacon interval.

21. The method of claim 16, wherein the scheduling information causes the one or more devices in sleep mode or power save mode to:
remain asleep during transmissions of subsequent standard beacon signals, or
not download subsequent standard beacon signals.

22. The method of claim 16, further comprising:
receiving supported rates from each of the network devices in sleep mode or power save mode;
determine a highest supported data rate common to all of the network devices connected to the access point that are in sleep mode or power save mode; and
transmit the wake-up beacon signal at the highest common supported data rate.

23. The method of claim 16 comprising broadcast the wake-up beacon signals at a higher data rate than the standard beacon signals.

24. The method of claim 21, wherein the access point broadcasts multiple wake-up beacons, each at a different data rate, during a single beacon interval, and each different wake-up beacon is scheduled to be received by the one or more devices that support that data rate.

25. The method of claim 16 comprising broadcasting the wake-up beacon signals less frequently than the beacon interval.
